(19) United States
(12) Patent Application Publication
(10) Pub. No.: US 2024/0430626 A1
(43) Pub. Date: Dec. 26, 2024

(54) METHOD FOR OPERATING A HEARING DEVICE, AND HEARING DEVICE

(71) Applicant: Sivantos Pte. Ltd., Singapore (SG)

(72) Inventors: Claudia PISCHEL, Erlangen (DE); Maja SERMAN, Erlangen (DE); Rosa-Linde FISCHER, Erlangen (DE); Ronny HANNEMANN, Erlangen (DE)

(21) Appl. No.: 18/826,259

(22) Filed: Sep. 6, 2024

Related U.S. Application Data
(63) Continuation of application No. PCT/EP2023/087141, filed on Dec. 20, 2023.

(30) Foreign Application Priority Data
Jan. 2, 2023 (DE) 10 2023 200 008.3

(51) Int. Cl. H04R 25/00; G06F 3/01; G10L 25/66

(52) U.S. Cl. CPC H04R 25/505; G06F 3/012; G10L 25/66; H04R 25/554; H04R 2225/55

(57) ABSTRACT

A method for operating a hearing device, in particular a hearing aid. The hearing device has a microphone, a control unit coupled thereto, and also a receiver. The microphone is used to produce an audio signal containing voice components from the wearer of the hearing device. The voice components are taken as a basis for estimating a state of health of the wearer of the hearing device, and a setting of the hearing device is selectively altered as a function of the state of health. There is also disclosed a method for operating a hearing device system with a hearing device and a portable device, as well as a hearing device.

### CROSS-REFERENCE TO RELATED APPLICATION

This application is a continuation, under 35 U.S.C. § 120, of copending International Patent Application PCT/EP2023/087141, filed Dec. 20, 2023, which designated the United States; this application also claims the priority, under 35 U.S.C. § 119, of German Patent Application DE 10 2023 200 008.3, filed Jan. 2, 2023; the prior applications are herewith incorporated by reference in their entirety.

### FIELD AND BACKGROUND OF THE INVENTION

The invention relates to a method for operating a hearing device and to a method for operating a hearing device system that includes a method for operating a hearing device. The invention also relates to a hearing device. The hearing device may be a hearing aid in each case.

Individuals who suffer from a reduction in hearing capability normally use a hearing aid. This usually involves using a microphone, that is to say an electromechanical sound transducer, to convert ambient sound into an electrical (audio/sound) signal, with the result that the electrical signal is produced. The electrical signals are processed by way of an amplifier circuit and introduced into the auditory canal of the individual by way of another electromechanical transducer in the form of a receiver. The amplifier circuit is part of a control unit of the hearing aid. In most cases, the sound signals are processed, which is normally accomplished by using a signal processor of the amplifier circuit. The gain for this is tailored to a potential hearing loss of the hearing device wearer.

In most cases, the reduction in hearing capability is age-related. The individual using the hearing device on account of age often also has additional conditions that can lead to a deterioration of the state of health. It is also possible for the reduction in hearing capability to result in the occurrence of accompanying diseases, for example a depression. This can mean that there may be lethargy preventing the individual from using or correctly operating the hearing aid, with the result that the reduction in hearing capability is not compensated for, leading to an intensification of the depression. In most cases, the onset of such a depression is insidious, which is why it is usually recognized only comparatively late by the individual themself and also by others. When the depression is recognized, it is usually very advanced, and so comparatively extensive treatment is required.

### SUMMARY OF THE INVENTION

The invention is based on the object of specifying a particularly suitable method for operating a hearing device and also a particularly suitable method for operating a hearing device system and a particularly suitable hearing device, in which comfort and/or functionality, specifically with regard to the detection of the state of health of the hearing device wearer, is increased in particular.

With the above and other objects in view there is provided, in accordance with the invention, a method of operating a hearing device, which includes a microphone, a control unit coupled thereto, and a receiver, the method comprising:
using the microphone to produce an audio signal containing voice components from a wearer of the hearing device;
taking the voice components as a basis for estimating a state of health of the wearer of the hearing device; and
altering a setting of the hearing device in dependence on the state of health of the wearer of the hearing device.

The method is used to operate a hearing device. By way of example, the hearing device is a set of headphones or it comprises a set of headphones. Particularly preferably, however, the hearing device is a hearing aid. The hearing aid is used to assist an individual suffering from a reduction in hearing capability. In other words, the hearing aid is a medical device that is used to compensate for a partial hearing loss, for example. The hearing aid is, by way of example, a receiver-in-the-canal (RIC; external receiver) hearing aid, an in-the-ear hearing aid, an in-the-canal (ITC) hearing aid or a completely-in-canal (CIC) hearing aid, hearing spectacles, a pocket hearing aid, a bone conduction hearing aid or an implant. Particularly preferably, the hearing aid is a behind-the-ear (BTE) hearing aid worn behind the user's pinna.

The hearing device is intended and configured to be worn on the human body. In other words, in the intended state the hearing device is worn by a wearer, who is also referred to as the beneficiary or user. Preferentially, the hearing device comprises a retaining apparatus by means of which it can be attached to the human body. If the hearing device is a hearing aid, the hearing device is intended and configured to be arranged for example behind the ear or inside an auditory canal. In particular, the hearing device is wireless and intended and configured to be introduced at least partially into an auditory canal. Particularly preferably, the hearing device comprises an energy store by means of which a supply of power is provided.

The hearing device comprises a microphone that is used to pick up sound. In particular, in operation the microphone picks up ambient sound, or at least a portion thereof. The microphone is in particular an electromechanical sound transducer. The microphone has for example just a single microphone unit or multiple microphone units that interact with one another. Each of the microphone units expediently has a diaphragm that is prompted to vibrate on the basis of sound waves, the vibrations being converted into an electrical signal by means of an appropriate recording device, such as a magnet that is moved in a coil. It is thus possible to use the respective microphone unit to produce an audio signal based on the sound that hits the microphone unit. The microphone units are in particular unidirectional. The microphone is expediently arranged at least partially inside a housing of the hearing device and thus at least partially protected.

The hearing device furthermore comprises a control unit coupled to the microphone. The control unit expediently comprises a signal processing unit or is formed by means of said signal processing unit. The signal processing unit is used in particular for further processing or at least analyzing the audio signal(s) produced by means of the microphone. In particular, the control unit is used to process the audio signal, with the result that an output signal is produced that is altered compared with the audio signal. In particular, the control unit is used to boost specific frequencies of the audio signal, this preferably involving an adjustment being made for a potential hearing loss of the wearer. By way of example, the signal processing unit has multiple analog components. Expediently, the signal processing unit or at least the control unit comprises a digital sound processor (DSP). Expediently, the (sound) processor is a programmable system.

Furthermore, the hearing device has a receiver that is used in particular to output the output signal. The output signal is in particular an electrical signal. Expediently, the receiver is coupled to the control unit, in particular connected to said control unit for signal transfer purposes. Depending on the design of the hearing device, in the intended state the output apparatus is arranged at least partially inside an auditory canal of the wearer of the hearing device, that is to say an individual, or at least acoustically connected to said auditory canal.

The method involves using the microphone to produce an audio signal that has voice components from the wearer of the hearing device. In particular, the microphone is used to pick up ambient sound, and this is taken as a basis for producing the audio signal that has the voice components. The audio signal is expediently evaluated by means of the control unit, and the voice components from the wearer are identified therein. By way of example, identification involves analyzing the point of origin of the voice components, which is in particular accomplished by using a directional characteristic of the microphone. Alternatively, for example the hearing device stores (a) frequency (frequencies) of the voice of the wearer, and those components in the audio signal that have this (these) frequency (frequencies) are used as voice components. The method is thus at least carried out when the audio signal contains the voice components. If said voice components are not present, the method is in particular terminated.

The voice components are taken as a basis for estimating a state of health of the wearer of the hearing device. By way of example, a disease or degeneration, in particular age-related disease or degeneration, is estimated to exist. As an alternative to or in combination with this, the state of health has deteriorated owing to the estimated existence of an accompanying disease for a potential hearing loss. In particular, different classifications are available, and the voice components are taken as a basis for classifying the state of health. The individual classes correspond in particular to specific states of health that are presumed. By way of example, one of the classes corresponds to a good state of health, one of the classes corresponds to a slightly deteriorated state of health of the wearer, one of the classes corresponds to a moderately deteriorated state of health of the wearer, and/or one of the classes corresponds to a severely deteriorated state of health of the wearer—in summary, the voice components are thus taken as a basis for presuming what state of health the wearer of the hearing device has.

In another operational step, a setting of the hearing device is altered according to the state of health, that is to say in particular the estimated state of health. In other words, there is a functional relationship between the change of setting and the estimated state of health. By way of example, the setting is adjusted continuously. Alternatively, there are only discrete changes to the setting. Particularly preferably, the individual classes for the state of health are available, each of the classes having, in particular, an associated corresponding setting. Effort for carrying out the method is thus reduced.

The method thus results in the state of health of the wearer being monitored at least in part by means of the hearing device without the wearer having to perform a particular activity to this end. This increases and improves comfort for the wearer. The setting of the hearing device is also altered, the change of setting expediently serving to improve the state of health. Here too, the wearer thus does not need to perform any additional activity, and so comfort is increased. The hearing device that the wearer is already wearing is used to perform other functions, specifically adjusting the setting of the hearing device for the estimated state of health, and so a functionality of the hearing device is increased.

By way of example, the state of health is estimated by determining the probability of the existence of a depression, in particular of a depressive episode. For example, the existence of the depression is determined merely in binary fashion, or the probability of the depression being severe is also determined too. In other words, in particular a probability of existence of a mild depression, a probability of existence of a moderate depression and/or a probability of existence of a severe depression is determined. If in particular the probability of existence of the depression is increased, then in particular a comparatively poor state of health is estimated.

The probability of the existence of the depression is determined by determining in particular the proportion of voice components in the audio signal. The proportion of voice components has a negative correlation with the existence of the depression, and so the probability of the existence of a depression is increased the smaller the proportion of voice components from the wearer in the audio signal. The voice components can thus be taken as a basis for estimating the state of health comparatively accurately. The probability of a depression occurring is also already increased due to the use of a hearing device, said depression usually not being perceived by others until comparatively late. The use of the method thus means that such a deteriorated state of health is estimated early, and so the depression can still be treated at an early stage. Comfort for the wearer and a functionality of the hearing device are thus increased.

Particularly preferably, the hearing device comprises a motion sensor that can be used to detect in particular a head movement of the wearer. The method involves detecting the head movement, and the state of health is in particular also estimated on the basis of the head movement. Also using the head movement to estimate the state of health means that an accuracy of the estimated state of health, that is to say concordance with the actual state of health, is increased. In particular, the audio signal and the head movement can be taken as a basis for determining the extent to which the wearer of the hearing device points their head in the direction of an acoustic source. If a depression exists, then in particular comprehension is hampered, and so excessive movement of the head or ear in the direction of the acoustic source results in the probability of existence of a depression being increased. In particular, an increased absence of head movements likewise results in a comparatively poor state of health being estimated, since for example the wearer lacks the motivation for a head movement and/or suffers pain when making head movements. As an alternative to or in combination with this, the detected head movement is taken as a basis for ascertaining whether and if applicable what physical activity is being carried out by the wearer. This involves in particular checking whether a light, medium or heavy physical activity is being carried out. This is in particular likewise taken as a basis for estimating the state of health. Preferably, the data provided by means of the motion sensor, that is to say in particular the detected head movement, are taken as a basis for ascertaining a gait and/or mobility patterns. Preferably, any change from this over a lengthy period is determined. Appropriately, these and/or the changes are likewise used to estimate the state of health.

As an alternative to or in combination with this, the hearing device comprises a GPS sensor, or the motion sensor is designed as a GPS sensor. In particular, the data provided by means of the GPS sensor are taken as a basis for checking the whereabouts of the wearer of the hearing device, which is in particular accomplished by also using map material. The respective whereabouts are in particular likewise used to estimate the state of health. As an alternative to or in combination with this, in particular the state of health is also estimated on the basis of settings changed on the control unit, these having been changed by an audiologist, for example. In particular, the state of health is estimated on the basis of audiometric data and/or a screening.

As an alternative to or in combination with this, the state of health is estimated by using the result of a questionnaire and/or evaluating said questionnaire. The questionnaire has been filled in by the wearer, for example. The responses on the questionnaire are input into or expediently transmitted to the hearing device, for example, in particular by means of a radio connection. As an alternative to or in combination with this, the hearing device itself is used to provide the questionnaire, for example, the receiver being used to output the questions, for example, which the wearer answers, evaluation of the audio signals being taken as a basis for determining in particular the response to the respective question.

By way of example, the setting is altered by increasing a directionality. In other words, in particular a directional characteristic is altered, which is expediently accomplished by altering a setting of the microphone. An increase in directionality results in components of the audio signal that originate from a preferential direction preferably being boosted, whereas the remaining components are attenuated or at least reduced. Intelligibility of audio sources lying in the preferential direction is thus in particular increased for the wearer.

As an alternative to or in combination with this, a noise rejection is adjusted, so that said noise rejection is altered according to the state of health. In particular if the state of health is comparatively poor, the noise rejection is intensified, and so speech intelligibility is increased. As an alternative to or in combination with this, the setting of the hearing device is altered by altering a gain factor, the gain factor being used to convert the audio signal into the potential output signal. By way of example, the gain factor is increased uniformly for all frequencies, or the gain factor is different for individual frequencies, and so the gain for altering the settings is adjusted on a frequency-selective basis.

As an alternative to or in combination with this, a program for getting used to the hearing device is altered according to the state of health, the program resulting in particular in a gain being adjusted for a potential hearing loss gradually. The setting is altered for example by altering the starting point, or the ending point, of the program, that is to say in particular the frequency-selective gain that is used initially, or that is supposed to be used during normal operation. In another alternative, the speed of the change of gain is adjusted according to the state of health, for example, and so this is the alteration of the setting.

By way of example, the setting of the hearing device is altered such that the receiver is used to output a recommendation. This involves outputting in particular the recommendation to carry out a particular activity, for example to meditate, or to carry out a physical activity, for example to go for a walk. As an alternative to or in combination with this, in particular the recommendation to go to a different location, in which there is a lower noise level, for example, is output. This can lead to an improvement in the state of health. As an alternative to this, the recommendation is such that it teaches the wearer to use the hearing device. As such, for example a voice signal is output that is used to instruct the wearer to turn their head in a particular direction, such a head movement in particular improving intelligibility for the wearer. In particular, the recommendation corresponds to easier operation or use of the hearing device, and so the wearer gets used to the hearing device, which can likewise lead to an improvement in the state of health. In particular, the recommendation contains tips for operating or using the hearing device and/or an incentive to do so.

By way of example, the receiver is used to output what sounds the audio signal contains, with the result that the wearer has their attention drawn to this, and endeavors to hear them too. Alternatively or in combination, the recommendation is to carry out a training or for example to start a training mode, with the result that use of the hearing device is simpler for the wearer. As an alternative to or in combination with this, the recommendation comprises comparison with other hearing device wearers, with the result that in particular a competitive comparison is made with other individuals, thereby increasing an incentive to use the hearing device. In this way, the state of health is improved, in particular.

In summary, the recommendation is used to teach the wearer of the hearing device self-help. If the state of health is comparatively poor, then in particular the recommendation to visit a specialist or doctor is output.

Preferably, the hearing device has a communication apparatus that can be used to output a radio signal. In particular, the communication apparatus/radio signal complies with a Bluetooth, WLAN and/or mobile radio standard. Preferably, the radio signal is output by means of the communication apparatus as an alteration of the setting. If the state of health is comparatively poor, it is conveyed to an assistance center or a specialist, for example, by means of the radio signal. Expediently, a very poor state of health results in the radio signal being sent in the style of an emergency call, with the result that in particular first aiders are alerted on the basis of the radio signal. By way of example, the radio signal is output constantly, or only if the wearer of the hearing device agrees.

By way of example, the communication apparatus is used to retrieve the state of health of other wearers, in particular anonymously, from a database and to produce a comparison with the state of health. Expediently, the comparison is output as a change of setting.

In one exemplary embodiment, the state of health is estimated only once. In a preferred embodiment, however, the state of health is estimated again after a period of time, which is in particular accomplished by producing the audio signal again, and/or other data taken as a basis for estimating the state of health are determined again after a period of time. In summary, after the period of time has elapsed, all data that can be taken as a basis for estimating the state of health are determined again, in particular, and the state of health is estimated on the basis of these data. The period of time is constant, for example, or defined on the basis of an event to be triggered. In other words, the period of time is at an end when the triggering event occurs.

The setting of the hearing device is expediently again altered as appropriate according to the state of health. The freshly estimated state of health is compared with the previous estimated state of health. In particular, a change in the state of health is determined. Appropriately, the change is output and/or the two estimated states of health and/or the change are expediently stored in a memory of the hearing device, with the result that a trend in the state of health of the wearer over time can be determined therefrom. Particularly preferably, all estimated states of health are stored in the memory of the hearing device, enabling the device to provide for a historical progression of the state of health.

With the above and other objects in view there is also provided, in accordance with the invention, a further method for operating a hearing device system. The hearing device system comprises a hearing device, which has a microphone and a control unit coupled thereto and also a receiver. The receiver is expediently coupled to the control unit. Furthermore, the hearing device system comprises a portable device that includes a display. In particular, the portable device, which is also referred to merely as a device, is a cell phone, preferably a so-called smartphone or other portable. Expediently, the display is also designed as an input device, and so it can be used to make inputs.

The method provides for the hearing device to be operated using a method that involves using the microphone to produce an audio signal containing voice components from the wearer of the hearing device. The voice components are used to estimate a state of health of the wearer of the hearing device, and a setting of the hearing device is altered according to the state of health. Furthermore, a notification is produced, production of the notification being the alteration of the setting of the hearing device, for example. As an alternative to this, the setting is altered in addition to the notification being produced. The notification is exchanged between the hearing device and the device. Appropriately, the hearing device has a communication apparatus, and the notification is exchanged between the hearing device and the device in particular wirelessly, preferably by radio. Expediently, this is accomplished by using a Bluetooth standard.

Based on the notification, the display of the device is used to output a message. The message corresponds to the notification, for example, or the notification contains the message, the notification also comprising additional information, for example. In particular, the display is used to output the estimated state of health and/or the alteration made to the setting. The wearer of the portable device, who is in particular the wearer of the hearing device, can thus see the altered setting, and/or is aware of the estimated state of health.

With the above and other objects in view there is also provided, in accordance with the invention, a hearing device system that is operated in accordance with the above-outlined method and that comprises the hearing device and also the portable device. In the intended state the portable device is carried by the wearer of the hearing device. Preferably, it is possible to use the display to make inputs, these being conveyed in particular to the hearing device. Expediently, the inputs are also taken as a basis for estimating the state of health. Preferably, the portable device is used to produce a radio connection to a remote server or to the Internet, data in particular being retrieved from a server, preferably from a database. Appropriately, estimated states of health of other wearers are retrieved, which are then output by means of the display, for example. In this way, the wearer of the hearing device is notified of how their state of health is in comparison with other wearers, and so in particular an incentive to use the hearing device is increased for said wearer. Appropriately, the estimated state of health is likewise conveyed to the server or at least to the database.

The hearing device has a microphone, a receiver and a control unit. The microphone is coupled to the control unit, which in turn is appropriately coupled to the receiver. The microphone, the control unit and the receiver form a signal path, in particular, and the microphone is preferably used to pick up sound and the receiver is appropriately used to output sound. By way of example, the hearing device is a set of headphones or comprises a set of headphones. By way of example, the hearing device is designed as a so-called headset. Particularly preferably, however, the hearing device is a hearing aid. The hearing aid is used to assist an individual suffering from a reduction in hearing capability (hearing loss). In other words, the hearing aid is a medical device that is used to compensate for a partial hearing loss, for example. The hearing aid is, by way of example, a receiver-in-the-canal (RIC; external receiver) hearing aid, an in-the-ear hearing aid, an in-the-canal (ITC) hearing aid or a complete-in-canal (CIC) hearing aid, hearing spectacles, a pocket hearing aid, a bone conduction hearing aid or an implant. Particularly preferably, the hearing aid is a behind-the-ear hearing aid worn behind a pinna.

The hearing device is operated using a method that involves using the microphone to produce an audio signal containing voice components from the wearer of the hearing device. The voice components are taken as a basis for estimating a state of health of the wearer of the hearing device. A setting of the hearing device is altered according to the state of health. Preferably, at least part of the method is carried out by means of the control unit, and the control unit is in particular suitable, expediently intended and configured, to carry out the method.

The hearing device expediently comprises a signal processor that appropriately forms, or is at least a part of, the control unit. By way of example, the signal processor is a digital signal processor (DSP) or produced by means of analog components. The signal processor is in particular also used to adjust the audio signal, preferably according to a potential hearing loss of a wearer of the hearing device. Expediently, the microphone and the control unit, for example the signal processor, have an A/D converter arranged between them, if the signal processor is designed as a digital signal processor. Alternatively, the A/D converter is a part of the control unit. The signal processor is fine-tuned in particular according to a parameter set. The parameter set is used to specify a gain in different frequency ranges, with the result that the audio signal is processed in accordance with particular specifications, in particular according to a hearing loss of the wearer of the hearing device. The processed audio signal corresponds in particular to an output signal that is output by means of the receiver. Particularly preferably, the hearing device additionally comprises an amplifier, or at least part of the amplifier is formed by means of the signal processor. By way of example, the amplifier is connected upstream or downstream of the signal processor for signal transfer purposes.

It will be understood that the developments and advantages described in connection with the two methods are also applicable to the hearing device and the hearing device system, as well as vice versa.

Other features which are considered as characteristic for the invention are set forth in the appended claims.

Although the invention is illustrated and described herein as being embodied in a method for operating a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic view showing a wearer of a hearing device system that includes a hearing device and a portable device;

FIG. 2 is a schematic diagrammatic view of the hearing device system; and

FIG. 3 is a flowchart illustrating a method for operating the hearing device system according to the invention.

Mutually corresponding parts are identified with the same reference signs throughout the figures.

### DETAILED DESCRIPTION OF THE INVENTION

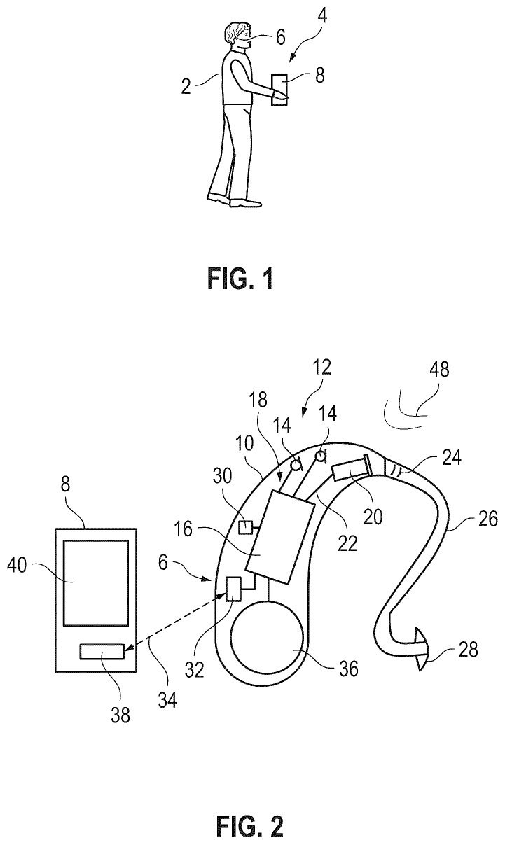

Referring now to the figures of the drawing in detail and first, in particular, to FIG. 1 thereof, there is shown a schematic depiction of a wearer 2 of a hearing device system 4 in simplified fashion. The wearer 2 is a person who, on account of their age, suffers from a partial hearing loss. To remedy this, the wearer 2 wears a hearing device 6 of the hearing device system 4. The hearing device system 4 furthermore has a portable device 8 in the form of a smartphone, which the wearer 2 also carries with them. On account of their age, there is the possibility of other diseases arising for the wearer 2, so-called accompanying diseases.

The hearing device system 4 is depicted in more detail in FIG. 2. The hearing device 6 is in the form of a hearing aid that is intended and configured to be worn behind an ear of the wearer (beneficiary, user, hearing device wearer) 2. In other words, it is a behind-the-ear hearing aid. The hearing device 6 comprises a housing 10, which is made from a plastic. Arranged inside the housing 10 is a microphone 12 having two microphone units 14, each in the form of an electromechanical sound transducer, which are omnidirectional. The two microphone units 14, that is to say the microphone 12, are coupled to a control unit 16 for signal transfer purposes, said control unit comprising a signal processing unit having an amplifier circuit, which is not shown in more detail, and a signal processor. The control unit 16 is furthermore formed by means of circuit elements, for example electrical and/or electronic components. The signal processor is a digital signal processor (DSP) and connected to the microphone units 14 via an A/D converter, which is not depicted in more detail, for signal transfer purposes.

During operation, each of the microphone units 14 is used to produce a respective electrical signal, these being combined to form an audio signal 18. By altering a time offset between the electrical signals recorded by means of the omnidirectional microphone units 14 it is possible to alter a directional characteristic of the microphone 12, and so a directional microphone is produced.

The control unit 16 has a receiver 20 coupled to it, that is to say connected to it for signal transfer purposes. The receiver 20, which is an electromechanical sound transducer, is used during operation to convert an output signal 22 provided by means of the control unit 16 into output sound 24, that is to say into sound waves. These are introduced into a sound tube 26, one end of which is attached to the housing 10. The other end of the sound tube 26 is enclosed by means of a dome 28, which in the intended state is arranged in an auditory canal, not depicted in more detail, of the wearer 2 of the hearing device 6. The dome 28 has multiple openings, and so wearing comfort is increased.

The housing 10 furthermore has a motion sensor 30 arranged in it, which comprises an inertial measurement unit and a GPS sensor. It is thus possible to use the motion sensor 30 to determine a position of the hearing device 6 and thus also of the head of the wearer 2. Moreover, the housing 10 has a communication apparatus 32 arranged in it, which is used to produce a radio connection 34 to the portable device 8. The communication apparatus 32 and thus also the radio connection 34 comply with a Bluetooth standard. The motion sensor 30 and the communication apparatus 32 are controlled by means of the control unit 16 and supplied with current via said control unit. Said control unit is also used to supply the microphone 12 and the receiver 20 with electrical energy. Current is supplied to the control unit 16 by means of a battery 36 arranged in the housing 10.

The portable device 8 designed as a smartphone has another communication apparatus 38, which is connected to the communication apparatus 32 of the hearing device 6 via the radio connection 34 during operation. For this purpose, the other communication apparatus 38 complies with the Bluetooth standard. Moreover, it is possible to use the other communication apparatus 38 to make a connection to the Internet and thus retrieve data from a server. For this purpose, the other communication apparatus 38 moreover complies with a mobile radio standard. The portable device 8 furthermore has a display 40, which is touch-sensitive. It is thus possible to use the display 40 to output information, and said display can also be used by the wearer 2 to make inputs.

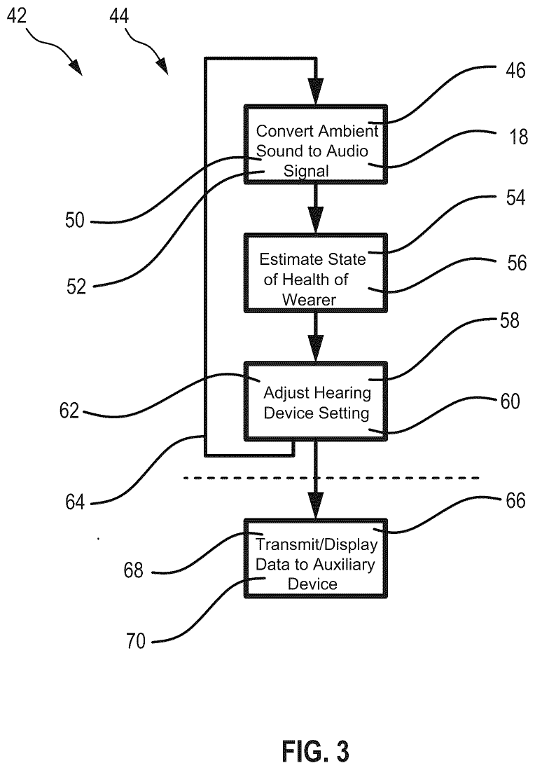

FIG. 3 depicts a method 42 for operating the hearing device system 4, at least part of which is carried out by means of the control unit 16 and also a control unit, not depicted in more detail, of the portable device 8. The method 42 for operating the hearing device system 4 first involves carrying out a method 44 for operating the hearing device 6.

In a first work step 46, the microphone 12 is used to pick up ambient sound 48 and to convert it into the audio signal 18. In other words, the microphone 12 is used to produce the audio signal 18. Said audio signal also contains voice components 50 from the wearer 2, specifically when the wearer 2 speaks, and so at least part of the ambient sound 48 has been brought about due to the wearer 2 speaking. The control unit 16 is used to identify the voice components 50 that the audio signal 18 contains, which is in particular accomplished by performing a frequency analysis of the audio signal 18. The proportion of voice components 50 in the audio signal 18 and the times of occurrence are determined. A head movement 52 of the wearer 2 is also detected by means of the motion sensor 30 in the first work step 46. A correlation analysis for the times of occurrence of the head movements 52 and the times of occurrence of the voice components 50 and also other components that the audio signal 18 contains, which represent human voice, is also carried out.

In a subsequent, second work step 54, a state of health 56 of the wearer 2 is estimated. The state of health 56 is estimated on the basis of the voice components 50 and the head movement 52. The state of health 56 is estimated by determining the probability of existence of a depression in the wearer 2. This involves determining the probability of existence of no depression, of existence of a mild depression, of existence of a moderate depression and of existence of a severe depression.

This is accomplished by using firstly the correlation between the occurrence of the head movements 52 and the time of occurrence of the voice components 50. Secondly, the correlation between the times of occurrence of the head movements 52 and the times of occurrence of the other components that the audio signal 18 contains, which represent human voice, is used. If head movements 52 are increasingly present when other human voice occurs, this suggests that the wearer 2 is having difficulties understanding human voice. This aspect also exists when a depression is present. The probability of a depression being present and also the level of said depression are thus greater the more distinct the head movements 52 turn out to be. If the proportion of voice components 52 from the wearer 2 is comparatively small, the probability of existence of a depression is also increased, the probability of a more severe depression being increased the fewer voice components 52 are present.

If the probability of existence of no depression is greatest, a good state of health 56 is presumed. If the probability of existence of a mild depression is greatest, a slightly deteriorated state of health 56 is presumed. If the probability of existence of a moderate depression is greatest, a deteriorated state of health 56 is presumed, and if the probability of a severe depression is greatest, a greatly deteriorated state of health 56 is presumed. Classification is thus performed, and the estimated state of health 56 can assume only one of four different characteristics.

In a subsequent, third work step 58, a setting of the hearing device 6 is altered according to the estimated state of health 56. If the slightly deteriorated state of health 56 exists, a directionality is adjusted. This involves altering the time offset between the electrical signals recorded by means of the omnidirectional microphone units 14, with the result that the directional characteristic of the audio signal 18 and thus also of the output signal 22 is altered. Components of the ambient sound 48 and thus also of the audio signal 18 that come from a spatial region around a preferential direction are boosted, whereas the remaining components are attenuated. The apex angle of the spatial region is comparatively large for the slightly deteriorated state of health 56. If the deteriorated state of health 56 exists, on the other hand, the apex angle is reduced.

The setting of the hearing device 6 is also altered by adjusting a noise rejection that is used to filter out noise that the audio signal 18 contains, with the result that the proportion of noise in the output signal 20 is decreased. The proportion that is filtered out is increased the poorer the state of health 56.

If the severely deteriorated state of health 56 exists, the receiver 20 is used to output a recommendation 60, which is accomplished by altering the output signal 22 so that the output sound 24 contains additional voice components that have been recorded, for example, or that are generated. The recommendation 60 is used to ask the wearer 2 to seek treatment, or to visit a specialist. Alternatively or in combination, the communication apparatus 32 is used to output a radio signal 62. The radio signal is transmitted, by means of the radio connection 34, to the portable device 8 and forwarded from there to an emergency center or a hospital, with the result that a doctor is sent from there to examine the wearer 2, for example.

After a period of time 64 after the conclusion of the third work step 58, the first work step 46 is carried out again, followed by the second and third work steps 54, 58. The state of health 56 is thus estimated again after the period of time 64, and the setting is altered as appropriate. Moreover, a comparison with the previous state of health 56 is additionally carried out in the third work step 58. If the state of health 46 has not improved, the setting of the hearing device 6 is altered as though a poorer state of health 56 existed. As such, a constant slightly deteriorated state of health 56 results, for example, in the apex angle of the spatial region being chosen as though a poor state of health 56 existed.

After each performance of the third work step 58, the method 42 for operating the hearing device system 4 additionally involves a fourth work step 66 being carried out. Said work step involves a notification 68 being produced by means of the hearing device 6 and exchanged between the hearing device 6 and the device 8, which is accomplished by using the radio connection 34. The notification 68 contains the change made to the setting of the hearing device 6. It also includes the estimated state of health 56, and possibly a change with respect to the previous estimation if the state of health 56 has already been estimated at least twice.

The display 40 is used to output a message 70 that is based on the notification 68, the estimated state of health 56 being displayed to the wearer 2. If a recommendation 60 is output as the alteration of the setting of the hearing device 6, the recommendation 60 is likewise output by means of the message 70, and so it is presented to the wearer 2 visually. It is also possible to use the recommendation 60 to instruct the wearer 2 to carry out physical activities so that their state of health 56 improves. The physical exercises required for this are indicated by means of the display 40.

The invention is not limited to the exemplary embodiment described hereinabove. Rather, other variants of the invention can also be derived therefrom by a person skilled in the art without departing from the subject matter of the invention. In particular, all individual features described in connection with the exemplary embodiment can furthermore also be combined with one another in another way without departing from the subject matter of the invention.

The following is a summary list of reference numerals and the corresponding structure used in the above description of the invention:
2 wearer
4 hearing device system
6 hearing device
8 portable device, auxiliary device
10 housing
12 microphone
14 microphone unit
16 control unit
18 audio signal
20 receiver
22 output signal
24 output sound
26 sound tube
28 dome
30 motion sensor
32 communication apparatus
34 radio connection
36 battery
38 other communication apparatus
40 display
42 method for operating a hearing device system
44 method for operating a hearing device
46 first work step
48 ambient sound
50 voice component
52 head movement
54 second work step
56 state of health
58 third work step
60 recommendation
62 radio signal
64 period of time
66 fourth work step
68 notification
70 message

1. A method of operating a hearing device, which includes a microphone, a control unit coupled thereto, and a receiver, the method comprising:
using the microphone to produce an audio signal containing voice components from a wearer of the hearing device;
taking the voice components as a basis for estimating a state of health of the wearer of the hearing device; and
altering a setting of the hearing device in dependence on the state of health of the wearer of the hearing device.

2. The method according to claim 1, wherein the hearing device is a hearing aid to be worn by a hearing-impaired wearer.

3. The method according to claim 1, which comprises estimating the state of health by determining a probability of an existence of a depression.

4. The method according to claim 1, which comprises:
detecting a head movement of the wearer by a motion sensor of the hearing device; and
estimating the state of health by taking into account the head movement.

5. The method according to claim 1, which comprises adjusting at least one of a directionality or a noise rejection.

6. The method according to claim 1, which comprises outputting a recommendation via the receiver.

7. The method according to claim 1, which comprises outputting a radio signal with a communication apparatus.

8. The method according to claim 1, which comprises estimating the state of health again after a period of time and comparing the state of health with a previously estimated state of health.

9. A method of operating a hearing device system that includes a hearing device to be worn by a wearer and a portable device, the hearing device having a microphone, a control unit coupled to the microphone, and a receiver, and the portable device having a display, the method comprising:
operating the hearing device by:
using the microphone to produce an audio signal containing voice components from a wearer of the hearing device;
taking the voice components as a basis for estimating a state of health of the wearer of the hearing device;
altering a setting of the hearing device in dependence on the state of health of the wearer of the hearing device; and
producing a notification;
transmitting the notification from the hearing device to the portable device; and
outputting a message based on the notification via the display of the portable device.

10. A hearing device, comprising a microphone, a control unit coupled to said microphone, and a receiver, configured for operation by the method according to claim 1.

11. The hearing device according to claim 10, wherein the hearing device is a hearing aid to be worn by a hearing-impaired person.
